(19) United States
(12) Patent Application Publication
(10) Pub. No.: US 2023/0405579 A1
(43) Pub. Date: Dec. 21, 2023

(54) LABORATORY AUTOMATION USING LABWARE MOVEMENT

(71) Applicant: Life Technologies Corporation, Carlsbad, CA (US)

(72) Inventors: Keith MCKINLEY, Brier, WA (US); Godfrey PADILLA, Everett, WA (US); James DASCHEL, Eugene, OR (US); Ricardo NOYOLA LOZANO, Shoreline, WA (US); Ivan GODINEZ, San Diego, CA (US); William LAFERTY, Encinitas, CA (US)

(21) Appl. No.: 18/209,980

(22) Filed: Jun. 14, 2023

Related U.S. Application Data
(63) Continuation of application No. PCT/US2023/020261, filed on Apr. 27, 2023.
(60) Provisional application No. 63/336,113, filed on Apr. 28, 2022.

(51) Int. Cl. B01L 3/00; B01L 9/06; B01L 3/02

(52) U.S. Cl. CPC B01L 3/5025; B01L 9/06; B01L 3/0275; B01L 2200/18; B01L 2300/0829

(57) ABSTRACT

A system facilitating parallel laboratory operations which includes a plurality of labware components, and a plurality of processing heads configured to interact with the plurality of labware components is described. The system further includes a first set of actuators coupled to the plurality of processing heads and configured to actuate the plurality of processing heads along a first directional axis. The system further includes a second set of actuators configured to translate the plurality of labware components along at least a second directional axis and a third directional axis. The second set of actuators may include one or more magnetic levitation systems configured to cause movement of the plurality of labware components along the second directional axis and the third directional axis.

### CROSS REFERENCE TO RELATED APPLICATIONS

This application is a continuation of International Application No. PCT/US2023/020261, filed on Apr. 27, 2023, entitled, “LABORATORY AUTOMATION USING LABWARE MOVEMENT” which claims the benefit of priority of U.S. Provisional Application No. 63/336,113 filed on Apr. 28, 2022. All applications are incorporated by reference herein in their entirety.

### BACKGROUND

Various types of experiments and/or tests utilizing liquid biosamples are performed in life science laboratories, such as antibody testing, genetic analysis, drug screening, cell therapy experiments, protein analysis, and/or others. Pursuant to such experiments, liquid biosamples are typically transferred among different vessels and/or substrates of various types and/or volumes. The number of transfers required for such experiments can be formidable in certain conditions, such as when investigating multiple combinatorial conditions. In such circumstances, liquid handling by hand can be tedious, difficult, and/or prone to human error.

This challenge has given rise to liquid handling robot (LHR) technologies, where programmable, sensor-integrated robotic systems are utilized to automate liquid handling processes associated with liquid biosamples. Conventional LHR systems typically utilize a pipettor or gripper attached to a robotic arm or gantry configured for 3-axis movement to move the pipettor or gripper to various labware components to facilitate liquid handling tasks.

However, existing LHR systems suffer from a number of shortcomings. There is an ongoing need and desire for improved systems and methods for facilitating automated lab operations.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Implementations of the present disclosure extend at least to laboratory automation using labware movement.

Some embodiments provide a system for facilitating parallelized lab operations. The system includes a plurality of labware components and a plurality of processing heads configured to interact with the plurality of labware components to facilitate a plurality of parallel lab operations. The system further includes a first set of actuators coupled to the plurality of processing heads. The first set of actuators is configured to actuate the plurality of processing heads along a first directional axis, singly or in parallel, to facilitate the plurality of parallel lab operations. The system further includes a second set of actuators configured to translate the plurality of labware components along at least a second directional axis and a third directional axis. The second directional axis and the third directional axis are angularly offset from the first directional axis and from one another. The second set of actuators is configurable to selectively translate at least some of the plurality of labware components into alignment with the plurality of processing heads preparatory to actuation of the plurality of processing heads along the first directional axis via the first set of actuators to facilitate the plurality of parallel lab operations.

Some embodiments provide a method for facilitating parallelized lab operations. The method includes translating, via a second set of actuators, a first labware component of a plurality of labware components into alignment with a first processing head of a plurality of processing heads. The second set of actuators is configured to translate labware components of the plurality of labware components along at least a second directional axis and a third directional axis. The method further includes translating, via the second set of actuators, a second labware component of the plurality of labware components into alignment with a second processing head of the plurality of processing heads. The method further includes actuating, via a first set of actuators, the first processing head and the second processing head in parallel to cause the first processing head to interact with the first labware component and to cause the second processing head to interact with the second labware component. The first set of actuators is coupled to the plurality of processing heads and is configured to actuate the plurality of processing heads along a first directional axis that is angularly offset from the second directional axis and the third directional axis.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings.

FIG. 1 illustrates example components of an example system for facilitating parallelized lab operations, in accordance with implementations of the present disclosure;

FIGS. 2A through 2C illustrate a conceptual representation of operation of a system for facilitating parallelized lab operations, in accordance with implementations of the present disclosure;

FIG. 3 illustrates an additional example of a system for facilitating parallelized lab operations, in accordance with implementations of the present disclosure;

FIGS. 4 through 7 illustrate example layouts of processing surfaces associated with systems for facilitating parallelized lab operations, in accordance with implementations of the present disclosure;

FIG. 8 illustrates an example graph comparing metrics associated with conventional LHR systems and estimated metrics of a system for facilitating parallelized lab operations according to implementations of the present disclosure; and

FIG. 9 illustrates an example flow diagram depicting acts associated with facilitating parallelized lab operations, in accordance with implementations of the present disclosure.

### DETAILED DESCRIPTION

Implementations of the present disclosure extend at least to laboratory automation using labware movement.

The disclosed embodiments may be implemented to address various shortcomings associated with at least some conventional LHR systems. As noted above, conventional LHR systems utilize robotic arms and/or gantries (movable in 3 axes) to facilitate movement of processing heads (for instance, pipettors, grippers) into communication with labware components (arranged at fixed positions) to perform liquid handling tasks. The use of robotic arms and/or gantries movable in 3 axes to facilitate liquid handling tasks severely limits the efficiency of conventional LHR systems. For example, such a system typically limits the number of processing heads that can simultaneously move into interaction with labware in view of the increased risk of collision posed by the use of multiple overhead robotic arms and/or gantries. Furthermore, while multiple processing heads may be affixed to a single robotic arm or gantry, the presence of multiple processing heads on the robotic arm or gantry may limit the reach of the robotic arm or gantry. Still furthermore, even where a robotic arm or gantry includes multiple processing heads, such components are only usable in parallel when the labware queued for interaction are positioned in close proximity to one another.

In view of at least some of the foregoing constraints, conventional LHR systems utilize one robotic arm or gantry (or few) to facilitate movement of processing heads for performing liquid handling tasks. Some robotic arms or gantries are able to exchange processing heads to perform different lab processes. In view of this limitation, typical LHR systems focus their functionality on in-series performance of ubiquitous liquid handling tasks, such as pipetting and gripping. This results in significant idle time for processing heads and/or labware components that are not part of the current process being performed by the conventional LHR system. Furthermore, in view of the focus on pipetting and gripping, conventional LHR systems provide for limited customizability to enable automation of additional lab processes.

In contrast with conventional LHR systems, which implement 3-axis movement of a robotic arm or gantry to facilitate automation of liquid handling tasks, embodiments of the present disclosure utilize separate actuation systems for causing movement of processing heads (for instance, pipettors, grippers, and/or others) and movement of the labware components themselves (for instance, liquid vessels and/or others). In one example, a system for facilitating parallelized lab operations includes (i) a first set of actuators coupled to a plurality of processing heads and configured to actuate the processing heads in at least a first direction and (ii) a second, separate set of actuators configured to translate a plurality of labware components in directions that are at least partially different than the first direction. For instance, the first set of actuators may be configured to actuate the processing heads in a vertical direction, and the second set of actuators may be configured to translate the labware components along a horizontal plane that is perpendicular to the vertical direction (other spatial/angular arrangements are within the scope of the present disclosure).

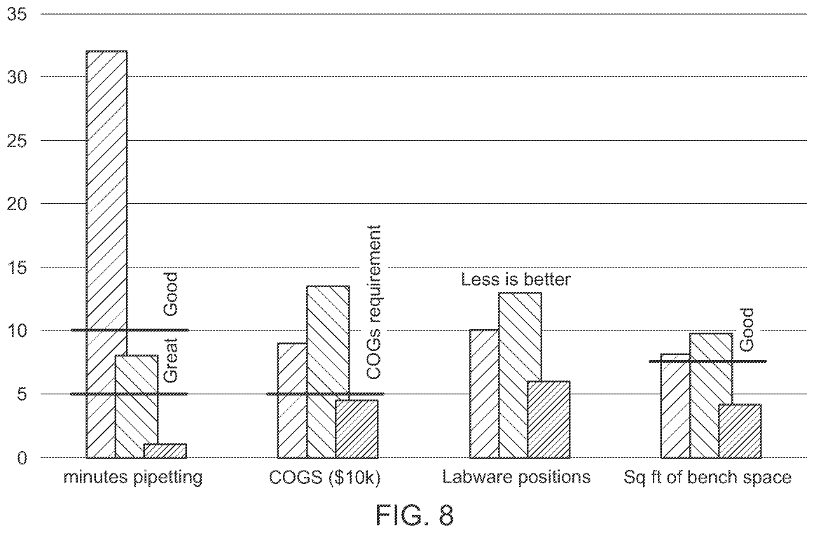

Embodiments that utilize different sets of actuators for labware components and for processing heads, in accordance with the present disclosure, may provide numerous advantages over conventional LHR systems. For example, disclosed embodiments may enable efficient performance of parallelized lab operations in a manner that is impossible under conventional LHR techniques. For instance, the second set of actuators may arrange multiple labware components under multiple processing heads in preparation for lab operations to be performed thereon (for instance, pipetting, vessel transfer, etc.), and the first set of actuators may actuate multiple processing heads into engagement with the multiple labware components in parallel. The second set of actuators may then proceed to move the processed labware components away from the processing heads and move a different set of multiple labware components under the processing heads in preparation for a subsequent lab operation. Such functionality may reduce the idle time for processing heads and/or labware components and may greatly increase the speed and/or efficiency with which liquid handling tasks may be performed in laboratory environments (see FIG. 8).

As used herein, “parallel” or “parallelized” operations refer to separate operations (such as those performed by separate processing heads on separate labware components) that are performed with any temporal overlap, such that any actions or sequences associated with performance of the separate operations are performed at the same time. In some instances, parallel lab operations comprise separate operations that are performed in synchrony (for instance, where multiple processing heads descend in the same direction simultaneously into engagement/interaction with labware components positioned thereunder, or where processing heads perform their tasks simultaneously, or where labware components are moved into position under processing heads simultaneously), whereas, in some instances, parallel lab operations comprise separate operations that are not performed in synchrony (for instance, where at least some aspects of actuation or task performance of processing heads and/or labware components occurs at the same time, but with different actions being performed, different rates of performance, different start times, different end times, different movement/rotation directions, different durations, etc.).

Because the disclosed systems are not necessarily required to accommodate multi-axis movement of a gantry or robotic arm over the labware components, the spatial footprint of the disclosed systems may be smaller than that of conventional LHR systems (while still matching or exceeding the performance of conventional LHR systems). Still furthermore, because multi-axis movement of the processing heads is not necessarily required in the disclosed systems, the disclosed systems may include multiple types of processing heads in addition to, or as an alternative to, pipettors and/or grippers, and such processing heads may be configured to perform their respective operations at least partially in parallel (for instance, where at least two processing heads perform their respective functions in parallel).

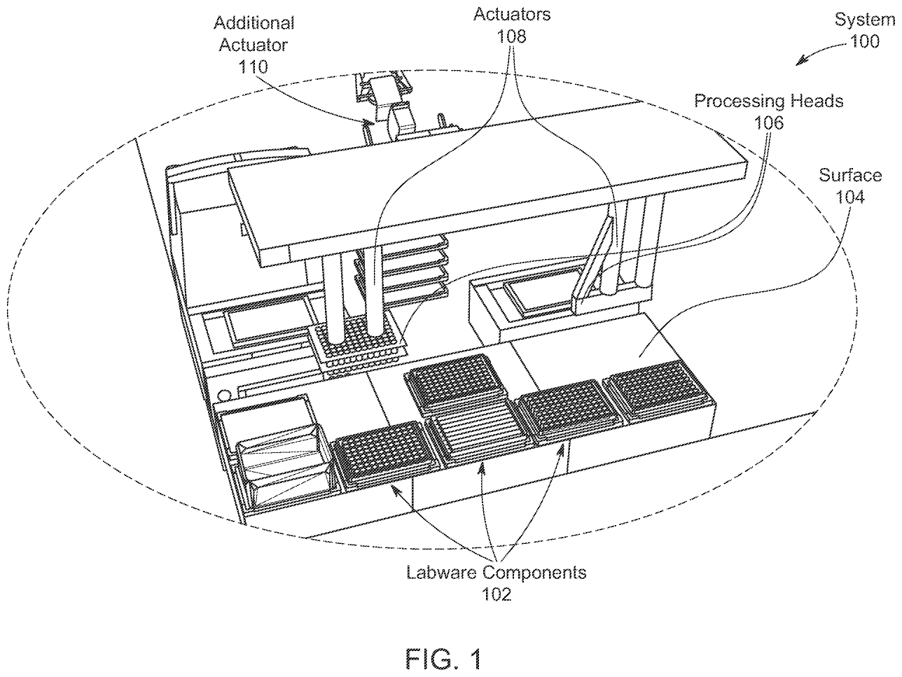

Having just described some of the various high-level features and benefits of the disclosed embodiments, attention will now be directed to FIGS. 1 through 9, which provide various supporting illustrations related to the disclosed embodiments.

### Example Systems and Techniques for Facilitating Parallelized Lab Operations

FIG. 1 illustrates example components of an example system 100 for facilitating parallelized lab operations. In the example of FIG. 1, the system 100 includes various labware components 102 positioned over a surface 104. The labware components 102 may comprise various types of fluid vessels usable in lab operations, such as, by way of non-limiting example, tubes, beakers, flasks, reservoirs, troughs, well plates, cell-culture dishes, slides, washing/cleaning solution reservoirs, priming solution reservoirs, and/or others. Other types of labware components 102 aside from fluid vessels are within the scope of the present disclosure, such as slide holders, tube holders, waste containers, bead holders, and/or others.

As will be described herein, the surface 104 may comprise or be associated with components of a set of actuators (for instance, a “second set of actuators”) configured to facilitate movement of the labware components 102 over the surface 104 (for instance, into alignment with processing heads 106) to facilitate parallelized lab operations.

FIG. 1 furthermore illustrates processing heads 106 that are configured to interact with the labware components 102 to perform parallelized lab operations. The processing heads 106 of FIG. 1 include a 12-channel pipette (right) and a 96-well head (left). However, additional or alternative processing heads are within the scope of the present disclosure, such as, by way of non-limiting example, other types of pipettors (for instance, single-channel or multi-channel such as 8-channel, 12-channel, 16-channel, 24-channel, 96-channel, 384-channel, 1536-channel, n-channel; with any capacity/capacities such as 250-500 uL, 1 mL, 5 mL, etc.; and/or with any type(s) of tips such as filtered tips, wide-bore tips, clear tips, liquid detection tips (conductive tips, pressure-based tips), magnetic application tips, etc.), grippers (for instance, single grippers, multi-grippers, rotatable grippers), dispensers (for instance, peristaltic or diaphragm-based dispensers), well washing devices, plate sealers, seal peelers, colony pickers, tube cappers/decappers, tube pickers, magnetic bead collection/transfer components, and/or pin tools.

The processing heads 106 may thus be usable to facilitate a wide variety of lab operations, which may be performed in parallel (for instance, when appropriate labware components are arranged thereunder via the second set of actuators). Such lab operations may include, by way of non-limiting example, single aspiration, serial aspiration, single dispensation, serial dispensation, tip changing, tip mixing, cherry picking, labware transfer, well washing, plate sealing, seal penetration or removal, colony picking, tube capping or de-capping, tube transfer, magnetic bead manipulation, and/or others. The processing heads may be plumbed to one or more fluid sources to facilitate their respective functions (for instance, plumbed to a priming solution source, washing solution source, vacuum/air source, etc.).

At least some of the lab operations may implement movement of the labware components via the second set of actuators. For instance, the second set of actuators may cause movement of a labware component (for instance, with or without a mixing tip of a processing head positioned within the fluid vessel(s) of the labware component) to cause mixing of the fluid within the fluid vessel(s) of the labware component. As another example, the second set of actuators may be configured to cause vertical or other movement of the labware components to assist with settling/cohesion/collection of fluids within the labware components (for instance, by tapping the labware components onto the surface 104). As yet another example, a processing head may be configured to lift one or more elements of a labware component, and the second set of actuators may reposition one or more other labware components to enable stacking of elements of labware components (and/or entire labware components).

FIG. 1 illustrates that the processing heads 106 are associated with actuators 108 (for instance, a “first set of actuators”) that are configured to facilitate movement of the processing heads 106 into proximity of the labware components 102 to enable the processing heads 106 to interact with the labware components pursuant to performance of the lab operations.

FIG. 1 also illustrates an additional actuator 110, which may comprise a robotic gripper or other device for moving labware components (and/or other elements, such as processing heads) onto or off of the surface 104 (for instance, onto or off of movable trays positioned over the surface 104). For example, the additional actuator 110 may be configured to move transfer labware components from over the surface 104 to a storage shelf, thermocycler, etc.

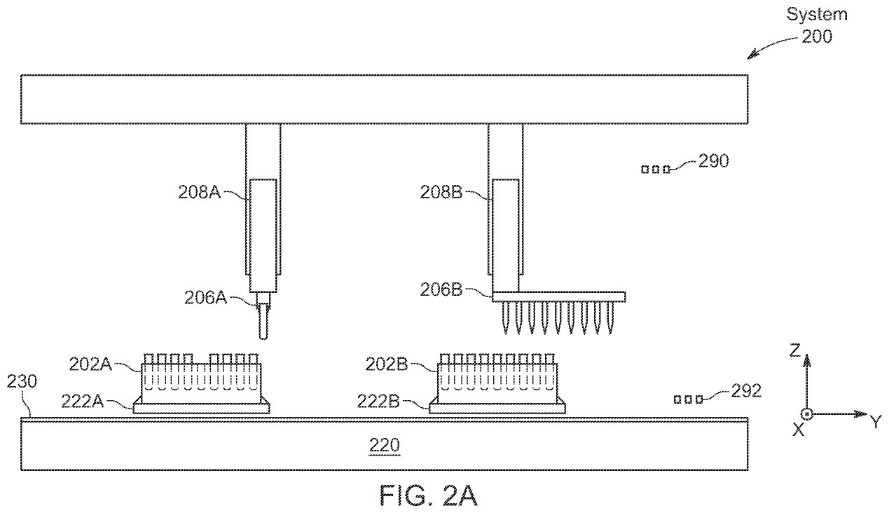

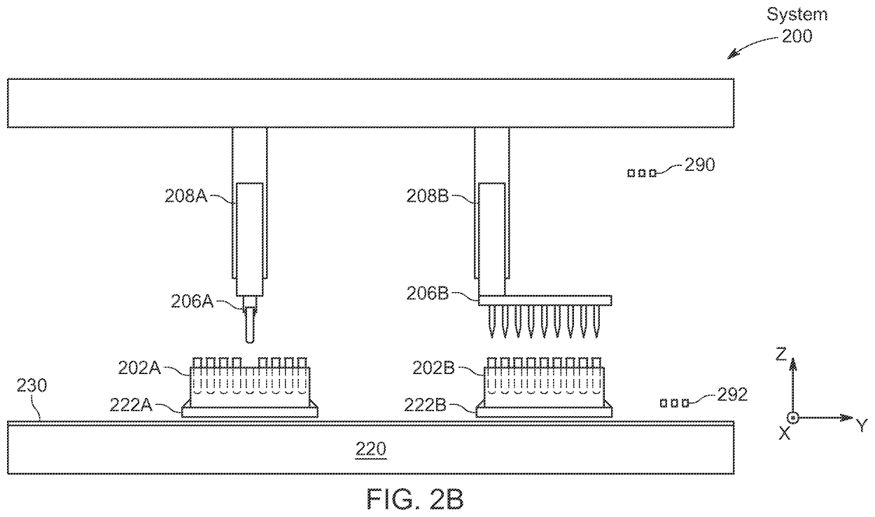

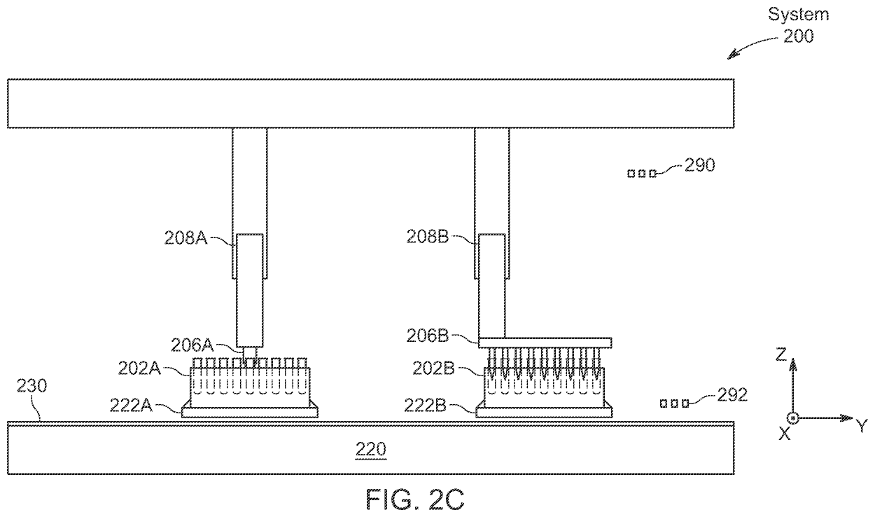

FIGS. 2A through 2C illustrate a conceptual representation of operation of a system 200 (similar in at least some respects to system 100) for facilitating parallelized lab operations. The example of FIG. 2A illustrates the system 200 as comprising labware components 202A and 202B (in the form of tubes within tube holders) and processing heads 206A and 206B (with processing head 206A implemented as a gripper and with processing head 206B implemented as a multi-channel pipettor).

One will appreciate, in view of the present disclosure, that the particular selection of labware components and/or processing heads of FIG. 2A are provided by way of example only and are not limiting of the principles disclosed herein. For instance, the ellipsis 290 indicates that any number of additional or alternative processing heads may be utilized in a system 200 for facilitating parallelized lab operations, and the ellipsis 292 indicates that any number of additional or alternative labware components may be utilized in a system 200 for facilitating parallelized lab operations. By way of example, a system 200 may include a set of processing heads that includes one or more pipettors (for instance, processing head 206B), one or more grippers (for instance, processing head 206A), and one or more additional processing heads. Such additional processing heads may include a combination of a dispenser and a well washing device, a combination of a plate sealer and a seal peeler, a combination of a tube capper/decapper and a tube picker, or other combinations. The ability to implement such combinations of processing heads in addition to a pipettor and gripper within a single device/unit (for instance, with each processing head arranged or fixed over the same working surface) comprises an improvement over many conventional LHR systems, which are limited to pipetting and gripping functionality (relying on off-device integrations that are not fixed/arranged over the same working surface to facilitate plate sealing and seal peeling, tube capping/de-capping and tube picking, dispensing and well washing, and/or other functions).

In the example of FIG. 2A, the processing heads 206A and 206B are coupled to actuators 208A and 208B (forming a first set of actuators), which are configured to actuate the processing heads 206A and 206B (for instance, independently) to enable the processing heads 206A and 206B to interact with the labware components 202A and 202B to facilitate the parallel lab operations. The actuators 208A and/or 208B may comprise any type(s) of actuator(s) that enable movement along a linear axis, such as ball screw actuators, linear actuators, and/or others.

In some instances, the actuators 208A and 208B are not configured to cause translation of the processing heads 206A and 206B in directions other than one direction of linear motion. For example, according to the axis shown in FIG. 2A, the actuators 208A and 208B may be configured to actuate the processing heads 206A and 206B along the z axis (for instance, a first directional axis) and may not be configured to actuate the processing heads 206A and 206B along the x axis (for instance, a second directional axis) or the y axis (for instance, a third directional axis). In this way, the processing heads may be regarded as arranged at fixed coordinates in the x-y plane. Such a configuration may eliminate the concern of processing heads colliding with one another or of needing to limit the number of processing heads positioned on a single robotic arm or gantry to enable sufficiently unrestricted 3-axis movement of the robotic arm or gantry. Thus, unlike conventional LHR systems, the system 200 may more readily enable implementation of any number of processing heads (for instance, 2, 3, 4, 5, 6, 7, 8, 9, or more than 9 processing heads) connected to any number of actuators (for instance, 2, 3, 4, 5, 6, 7, 8, 9, or more than 9 actuators) to enable any number of parallel lab operations (for instance, 2, 3, 4, 5, 6, 7, 8, 9, or more than 9 parallel lab operations) to be performed on any number of labware components (for instance, 2, 3, 4, 5, 6, 7, 8, 9, or more than 9 labware components).

As noted above, rather than having the actuators 208A and 208B move the processing heads 206A and 206B along the x-axis and the y-axis (for instance, the second and third directional axes, which are angularly offset from one another and from the first directional axis) to align the processing heads 206A and 206B with the labware components 202A and 202B, the system 200 comprises a second set of actuators configured to translate the labware components 202A and 202B along the x-axis and the y-axis to align the processing heads 206A and 206B with the labware components 202A and 202B in preparation for performance of parallel lab operations (for instance, in preparation for actuation of the processing heads 206A and 206B via the actuators 208A and 208B, respectively, to enable the processing heads 206A and 206B to engage with the labware components 202A and 202B, respectively).

A second set of actuators for moving the labware components 202A and/or 202B in the x-y plane may be implemented in various forms. For instance, FIG. 2A illustrates trays 222A and 222B supporting the labware components 202A and 202B, respectively. The trays 222A and/or 222B may comprise rollers and/or wheels configured to roll along a surface 230 to enable movement of the labware components 202A and 202B along the x-axis and the y-axis. As another example, rollers and/or wheels may be implemented on the surface 230, where the rollers and/or wheels are configured to interface with the trays 222A and 222B to cause movement of the trays 222A and 222B (or the labware components 202A and 202B directly in the absence of trays) along the x-axis and the y-axis. In this regard, a second set of actuators may comprise rollers and/or wheels (wherever positioned) to facilitate movement of the labware components (and/or trays positioned thereunder) along at least two directional axes.

The second set of actuators may take on additional or alternative forms. For example, second set of actuators may comprise a magnetic levitation system for causing movement of the labware components 202A and 202B. A magnetic levitation system may comprise a magnetic coil matrix 220 (shown in FIG. 2A as positioned beneath the surface 230) that is controllable to cause levitation of the trays 222A and 222B that support the labware components 202A and 202B. The trays 222A and 222B may comprise permanent magnets to enable the trays 222A and 222B to be levitated above the surface 230 in the z-axis direction (along with the labware components 202A and 202B) via operation of the magnetic coil matrix 220. In addition to levitation along the z-axis (for instance, first directional axis), the magnetic coil matrix 220 may be controllable to facilitate translation of the trays 222A and 222B (along with the labware components 202A and 202B) in the x-direction and/or the y-direction (for instance, along the second directional axis and the third directional axis).

Whether implemented utilizing rollers, wheels, magnetic levitation system(s), and/or other means, the second set of actuators may advantageously be configured to translate the plurality of labware components along the x-axis and the y-axis (for instance, the second directional axis and the third directional axis) without utilizing actuation or gripping members that extend above the plurality of labware components 202A and 202B for instance, along the x-axis or first directional axis. Implementation of such a second set of actuators can allow the labware components to move independently of and/or in parallel with the processing heads, allowing for rapid re-organization of the labware components in preparation for subsequent lab operations.

FIG. 2B illustrates an example of the trays 222A and 222B along with the labware components 202A and 202B, respectively, being translated via the second set of actuators for instance, by operation, in the example of FIG. 2B, of the magnetic coil matrix 220 and the magnetic trays 222A and 222B) into alignment with the processing heads 206A and 206B, respectively. FIG. 2C illustrates the processing heads 206A and 206B actuated into engagement with the labware components 202A and 202B, respectively, via the actuators 208A and 208B (forming the first set of actuators, as discussed above). In the example of FIG. 2C, processing head 206A performs a gripping operation on labware component 202A, and processing head 206B performs a pipetting operation on labware component 202B.

In some instances, lab operations are regarded as including movement of the labware component(s) into alignment with the processing heads (via the second set of actuators), movement of the processing heads toward the labware component(s) (via the first set of actuators), and/or operation of the processing heads upon the labware component(s). As noted above, lab operations may be performed in parallel (whether in synchrony or not, so long as at least a portion of each different operation is performed at the same time).

Although only two labware components 202A and 202B are shown in FIGS. 2A through 2C, it will be appreciated that, in some instances, the labware components 202A and 202B may be selected from a set of more than two labware components (with accompanying trays) that are positioned on the surface 230 and available for positioning into alignment with the processing heads 206A and 206B via the second set of actuators. Subsequent to the processing as shown in FIG. 2C, the processing heads may be withdrawn along the z axis (via the first set of actuators), and the second set of actuators may function to move the trays 222A and 222B (and/or other trays not shown in FIG. 2C) in preparation for subsequent lab operations.

In some implementations, the second set of actuators is configured to facilitate rotation of the labware components about the x-axis (roll), y-axis (pitch), and/or z-axis (yaw). For example, rotation about the x-axis and/or the y-axis may enable rapid movement liquid vessels in a manner that avoids spilling. As another example, rotation about the z-axis may advantageously enable repositioning/rearranging of labware components.

As noted above, the second set of actuators may be able to move labware components in the z-direction (for instance, via magnetic levitation or other means), such that both the first set of actuators and the second set of actuators are able to move the labware components in the z-direction. In some instances, a system 200 includes one or more sensors associated with the second set of actuators, where the sensor(s) are configured to detect changes in position of the labware component(s) (and/or trays) along the z-axis where such changes are not caused by the second set of actuators. For example, the sensor(s) may detect positional changes in z of the labware component(s) (and/or trays) caused by a processing head exerting downward force on labware component(s) (which may cause, for example, malfunctioning of a pipettor). Based upon such sensor data, the system 200 may be configured to selectively modify positioning of the labware component(s) (and/or trays) in z to ensure proper performance of the lab operation(s). For example, in response to detecting (via the sensor(s) associated with the second set of actuators) a downward change in the z position of a tray caused by a pipettor tip pushing downward on a labware component, the second set of actuators may cause the z position of the labware component to further lower to prevent pipette malfunctioning.

In some implementations, at least some of the processing heads of the system 200 are selectively interchangeable to enable further diversity of lab operations performable by the system 200 (without necessarily increasing the spatial footprint of the system 200). In some instances, to enable rapid and/or automatic changing of processing heads (or components thereof), one or more of the trays of a system 200 may be configured to support processing heads. Such trays may be actuated via the second set of actuators into alignment with the first set of actuators to enable selective connection and/or disconnection of processing heads to and/or from the first set of actuators. Processing heads may additionally or alternatively be configured to be selectively connected/disconnected from actuators in other ways (for instance, manually), thereby providing for modular lab systems that can be reconfigured with arbitrary complexity.

Similarly, in some instances, the processing head(s) of the system 200 utilize consumable components, such as consumable pipette tips, magnetic bead manipulation sleeves, and/or others. Accordingly, in some implementations, at least some trays of the system 200 are configured to support a receptacle for receiving used consumable components. The second set of actuators may translate such trays (and receptacles) into alignment with the processing heads to enable the processing heads to deposit consumable components thereof into the receptacles. Furthermore, at least some trays of the system 200 may be configured to support replacement consumable components, and such trays may align with the processing heads in a manner that enables the processing heads to receive or obtain the replacement consumable components in preparation for subsequent lab operations.

As shown and described with reference to FIGS. 2A though 2C, a system 200 for facilitating parallelized lab operations may comprise a surface 230 over which the labware components may translate in the x direction and/or the y direction (for instance, along the second directional axis and the third directional axis). Such a surface may comprise multiple zones associated with operation of the system 200 within a lab environment.

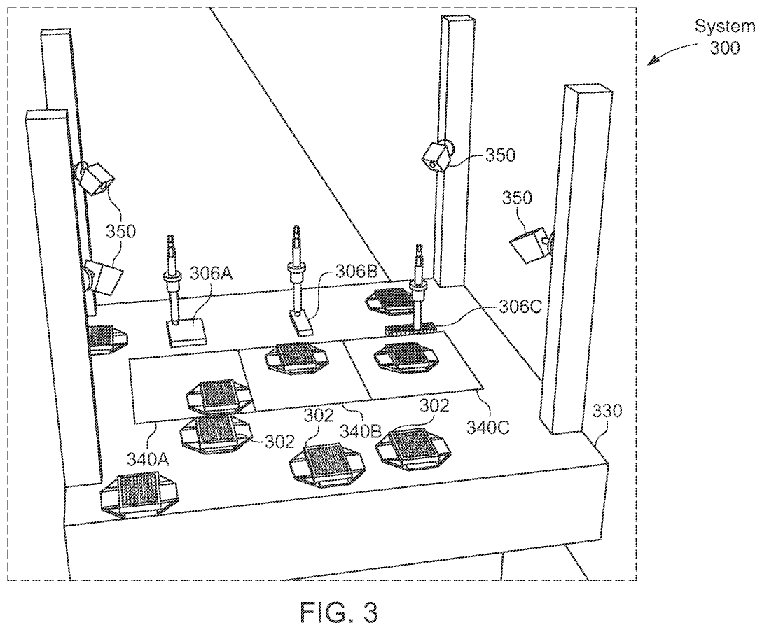

FIG. 3 illustrates a system 300 that corresponds conceptually to the system 200 of FIGS. 2A through 2C for facilitating parallelized lab operations. The system 300 includes three processing heads 306A, 306B, and 306C arranged over a surface 330 arranged underneath the labware components 302. In the example of FIG. 3, the surface 330 includes interaction zones 340A, 340B, and 340C associated with the different processing heads 306A, 306B, and 306C, respectively. The second set of actuators may translate appropriate labware components into the interaction zones 340A, 340B, and 340C pursuant to or in preparation for parallel lab operations.

The interaction zones 340A, 340B, and 340C may be sized to enable arrangement of the labware components 302 within the interaction zones 340A, 340B, and 340C in a manner that allows the processing heads 306A, 306B, and 306C to interact with any portion of the labware components 302 (for instance, with any corner of the labware components 302). Labware components 302 not intended for interaction with a processing head 306A, 306B, or 306C may be prevented from entering the interaction zones 340A, 340B, and 340C to prevent unwanted collisions between the labware components 302.

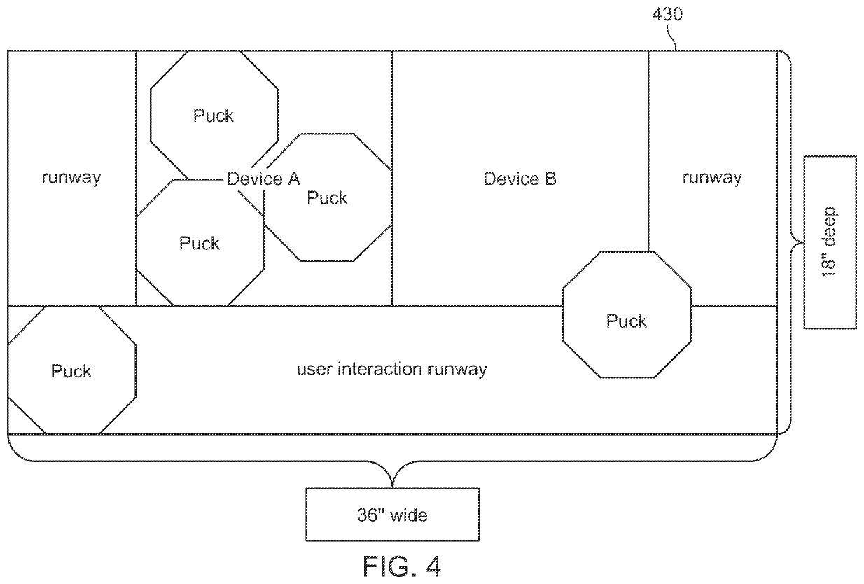

In some implementations, the surface over which the labware components are transported (via the second set of actuators) includes additional zones. For example, FIG. 4 illustrates an example surface layout 430 that includes interaction zones for two processing heads (labeled “Device A” and “Device B”) as well as runway zones (labeled as “runway”) to enable movement of labware components (or trays supporting or other components, labeled as “Puck”) to and from the interaction zones. The runway zones may also provide a place for labware components not currently queued for a lab operation to reside. The surface layout 430 of FIG. 4 also includes a user interaction zone (labeled “user interaction runway”), which is separate from the interaction zones. The second set of actuators may be configured to translate labware components to the user interaction runway to enable users to interact with the labware components (for instance, before or after lab operations). To this end, the user interaction zone(s) may be situated along one or more edges of a system to facilitate ease of access. The user interaction zone may additionally fulfill one or more functions of the runway zones described above.

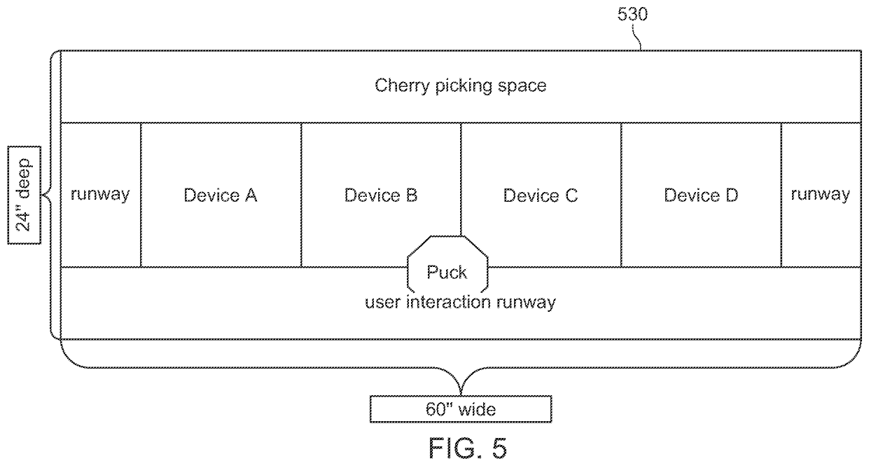

FIG. 5 illustrates another example surface layout 530 that includes interaction zones for four processing heads (labeled “Device A”, “Device B”, “Device C”, and “Device D”), runway zones, a user interaction zone (labeled “user interaction runway”), and a cherry-picking zone (labeled “cherry picking space”). In some instances, the cherry-picking zone may comprise a zone that is usable in combination with an interaction zone to facilitate cherry picking or hit picking operations (for instance, consolidation of samples that fit certain criteria). For instance, one or more labware components that include target assays may be transferred from the cherry-picking zone (or another zone) into one or more of the interaction zones to enable one or more processing heads to aspirate the target assays. The labware component(s) may then be removed from the interaction zone(s) (for instance, returning to the cherry-picking zone or to another zone), and one or more consolidation labware components may be moved into the interaction zone(s) (for instance, from the cherry-picking zone) to receive the target assays according to a desired organizational structure.

In some instances, the cherry-picking zone comprises a processing zone that includes additional processing heads for facilitating unique and/or complex processing (for instance, cherry picking or hit picking). For example, a cherry-picking zone may be associated with one or more additional processing heads (for instance, multiple independently operable pipettors) configured to interact thereover. The additional processing head(s) may be configured to move in multiple axes (for instance, in the x-direction and/or the y-direction in addition to the z-direction). For instance, to facilitate a cherry-picking operation, multiple pipettes may operate independently along the cherry picking zone (for instance, each moving in z, and x and/or y) by acting on different labware components (for instance, aspirating from different trays, different volumes, etc.) and subsequently dispensing their fluids to new positions (for instance, on a destination labware component).

The user interaction zone may additionally fulfill one or more functions of the runway zones described above.

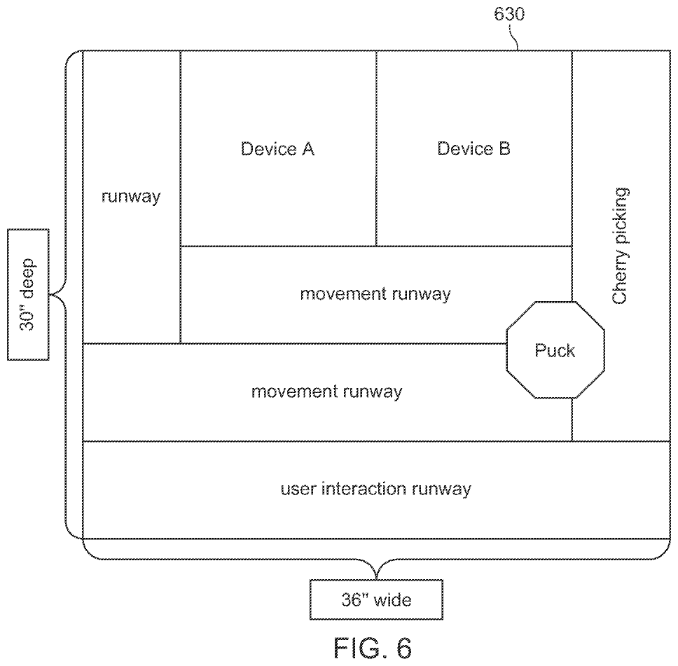

FIG. 6 illustrates an additional example surface layout 630 that includes interaction zones for two processing heads (labeled “Device A” and “Device B”), a runway zone, additional movement runways (fulfilling functions similar to those of the runway zone), a cherry picking zone (labeled “Cherry picking”) and a user interaction runway.

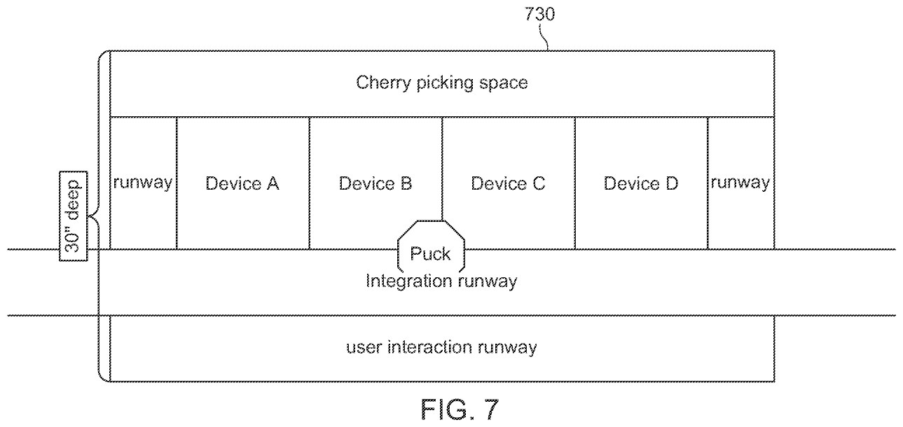

FIG. 7 illustrates another example surface layout 730 that includes interaction zones for four processing heads (labeled “Device A”, “Device B”, “Device C”, and “Device D”), runway zones, a user interaction zone (labeled “user interaction runway”), a cherry picking zone (labeled “Cherry picking space”), and an integration zone (labeled “Integration runway”). The second set of actuators may be configured to translate labware and/or other components onto the integration zone to enable one or more off-system components to interact with the labware components (for instance, thermocyclers, centrifuges, incubators, storage, and/or others). Although FIG. 7 illustrates the integration zone as extending beyond the main perimeter of the surface, other configurations are within the scope of the present disclosure.

One will appreciate, in view of the present disclosure, that the particular sizes, shapes, and/or arrangements of the various surfaces and/or zones thereof described hereinabove are provided by way of example only and are not limiting of the present disclosure.

The operations described hereinabove, such as operation of the first or second sets of actuators to facilitate movement of processing heads or labware or other components, the operation of processing heads and/or other components to perform lab operations, etc., may be effectuated by execution (via one or more processors) of instructions that are stored in one or more hardware storage devices. The execution of the instructions may refer to or rely on sensor data such as sensor data indicating displacement of labware components by processing heads (as discussed above). Referring briefly to FIG. 3, in some implementations, a system for facilitating parallelized lab operations as described herein includes one or more image sensors 350 configured to capture image data depicting one or more aspects of the system (for instance, labware components, processing heads, the first set of actuators, the second set of actuators, etc.). The system may utilize the image data to facilitate performance of the parallelized lab operations. For example, the system may utilize the image data to facilitate artificial intelligence (AI) driven actuation of the processing heads and/or labware or other components. The image data may additionally or alternatively be used to facilitate barcode scanning, error handling, position detection, accuracy detection, etc.

FIG. 8 illustrates an example graph comparing metrics associated with conventional LHR systems and estimated metrics of a system (for instance, system 100, system 200, system 300, and/or variants thereof) for facilitating parallelized lab operations according to implementations of the present disclosure. The performance metrics of FIG. 8 were captured for a bead-based nucleic acid purification process (for instance, part of a polymerase chain reaction (PCR) workflow) performed by a NIMBUS™ Liquid Handler with an 8-channel pipette (dark blue), a STARlet Liquid Handler with a 96-channel pipette (light blue). The estimated metrics for the system for facilitating parallelized lab operations according to the present disclosure (orange) are estimated for a system that utilizes an 8 channel pipette and a magnetic bead manipulation head (i.e., KingFisher™) on a system with an approximately 18″×30″ footprint The metrics measured (or projected/simulated, in the case of the system of the present disclosure) for performance of the bead-based nucleic acid purification process by the various systems were dedicated minutes of pipetting (for instance, where the system is unable to perform any other operations dependent on completion of pipetting), the cost of goods sold (COGS), the number of labware positions required throughout the process, and the square footage of bench space occupied by the system.

The graph of FIG. 8 shows that the disclosed system can complete the bead-based nucleic acid purification process with only 2 minutes of dedicated pipetting (i.e., other operations dependent upon completion of pipetting can commence after only 2 minutes of pipetting are complete, and the remainder of the pipetting (for instance, 13 or so remaining minutes) may proceed while other operations are occurring) (compared to 8 minutes of pipetting for the STARlet system and 32 minutes for the NIMBUS™ system), using only $45,000 in COGS (compared to $130,000 for the STARlet system and $90,000 for the NIMBUS™ system), using fewer labware positions than the existing systems, and occupying only 4 square feet of bench space (compared to 10 square feet for the STARlet system and 8 square feet for the NIMBUS™ system). As is evident from the graph of FIG. 8, the disclosed systems are able to achieve numerous and significant benefits in the field of liquid handling relative to existing systems.

A system may be able to complete a bead-based nucleic acid purification process as discussed above with less than 8 minutes of dedicated pipetting, less than $90,000 in COGS, requiring fewer than 10 labware positions, and/or requiring less than 8 square feet of bench space. As noted above, systems of the present disclosure may be adapted for different purposes (for instance, utilizing different combinations of processing heads, trays, labware components, actuators, etc.). Accordingly, one will appreciate, in view of the present disclosure, that the estimated results of FIG. 8 are provided by way of example only and are not limiting of the present disclosure.

Although the arrangement of various components and/or axes may be described herein utilizing particular coordinate systems (for instance, cartesian systems), the particular coordinate systems utilized are not limited of the present disclosure, and the arrangement of the components and/or axes described herein may be described according to any suitable coordinate system in accordance with the present disclosure (for instance, polar coordinates).

### Example Methods for Facilitating Parallelized Lab Operations

The following discussion now refers to a number of methods and method acts that may be performed (for instance, utilizing one or more systems that include components discussed herein,). Although the method acts are discussed and/or illustrated in a certain order, no particular ordering is required unless specifically stated, or required because an act is dependent on another act being completed prior to the act being performed. One will appreciate that certain embodiments of the present disclosure may omit one or more of the acts described herein.

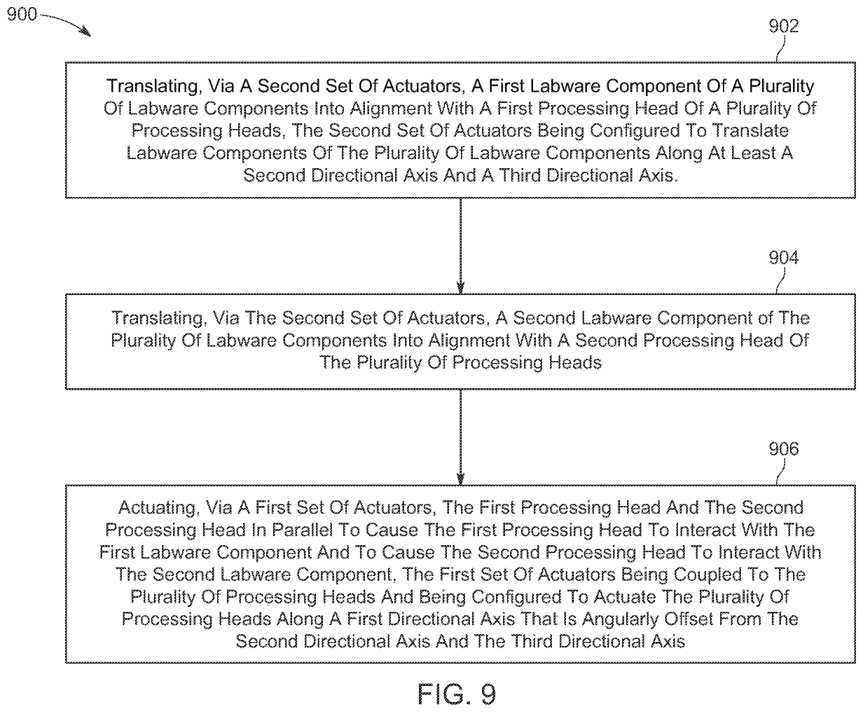

FIG. 9 illustrates an example flow diagram 900 depicting acts associated with facilitating parallelized lab operations, in accordance with implementations of the present disclosure. Act 902 of flow diagram 900 includes translating, via a second set of actuators, a first labware component of a plurality of labware components into alignment with a first processing head of a plurality of processing heads, the second set of actuators being configured to translate labware components of the plurality of labware components along at least a second directional axis and a third directional axis. In some implementations, the plurality of labware components comprises one or more fluid vessels, such as one or more tubes, beakers, flasks, reservoirs, troughs, well plates, cell-culture dishes, slides, slide holders, waste containers, and/or washing reservoirs. In some instances, the plurality of processing heads comprises one or more of pipettors, grippers, dispensers, well washing devices, plate sealers, seal peelers, colony pickers, tube cappers/decappers, tube pickers, magnetic bead collection/transfer components, and/or pin tools.

The plurality of processing heads may comprise one or more consumable components. The second set of actuators may be configured to translate at least one receptacle along the second directional axis and the third directional axis, and the at least one receptacle may be configured for delivering or receiving the one or more consumable components. The second set of actuators may be configured to translate the at least one receptacle to an integration zone.

In some implementations, the second set of actuators is configured to translate the plurality of labware components along the second directional axis and the third directional axis without utilizing actuation or gripping members that extend above the plurality of labware components on the first directional axis. In some instances, the second set of actuators is configured to rotate the plurality of labware components about the first directional axis, the second directional axis, and/or the third directional axis.

The second set of actuators may comprise a plurality of rollers or wheels configured to cause movement of the plurality of labware components along the second directional axis and the third directional axis.

In some implementations, the second set of actuators comprises one or more magnetic levitation systems configured to cause movement of the plurality of labware components along the second directional axis and the third directional axis. The one or more magnetic levitation systems may comprise a magnetic coil matrix and a plurality of magnetic trays. The plurality of magnetic trays can support the plurality of labware components, and the magnetic coil matrix may be controllable to facilitate levitation of the plurality of magnetic trays along the first directional axis and movement of the plurality of magnetic trays along the second directional axis and the third directional axis. In some instances, the second set of actuators comprises one or more magnetic systems that cause movement of the plurality of labware components along the second directional axis and the third directional axis without magnetic levitation (for instance, by magnetically securing labware components to actuatable movers).

The second set of actuators may be configured to translate the plurality of labware components along the second directional axis and the third directional axis over a surface. In some instances, the surface comprises a plurality of interaction zones, including a respective interaction zone for each of the plurality of processing heads. Translating the at least some of the plurality of labware components into alignment with the plurality of processing heads may comprise selectively translating the at least some of the plurality of labware components into the plurality of interaction zones. In some implementations, the surface further comprises one or more user interaction zones that are separate from the plurality of interaction zones. The second set of actuators may be configured to translate labware components of the plurality of labware components to the one or more user interaction zones to enable one or more users to interact with the labware components. The surface may further comprise one or more integration zones that are separate from the plurality of interaction zones. The second set of actuators may be configured to translate labware components of the plurality of labware components to the one or more integration zones to enable one or more off-system components to interact with the labware components.

Act 904 of flow diagram 900 includes translating, via the second set of actuators, a second labware component of the plurality of labware components into alignment with a second processing head of the plurality of processing heads.

Act 906 of flow diagram 900 includes actuating, via a first set of actuators, the first processing head and the second processing head in parallel to cause the first processing head to interact with the first labware component and to cause the second processing head to interact with the second labware component, the first set of actuators being coupled to the plurality of processing heads and being configured to actuate the plurality of processing heads along a first directional axis that is angularly offset from the second directional axis and the third directional axis. In some implementations, the plurality of parallel lab operations comprises one or more of single aspiration, serial aspiration, single dispensation, serial dispensation, tip changing, tip mixing, cherry picking, labware transfer, well washing, plate sealing, seal penetration or removal, colony picking, tube capping or de-capping, tube transfer, and/or magnetic bead manipulation.

In some instances, the plurality of the processing heads of the plurality of processing heads are selectively interchangeable. The first set of actuators may comprise one or more linear actuators, such as one or more ball screw actuators and/or linear actuators. In some instances, the actuators of the first set of actuators are not configured to cause translation of the plurality of processing heads along the second directional axis and the third directional axis, such that the plurality of processing heads are arranged at fixed coordinates on the second directional axis and the third directional axis. In some implementations, the second set of actuators is configured to move the plurality of labware components along the first directional axis.

In some implementations, the second set of actuators is configured to selectively modify positioning of the plurality of labware components along the first directional axis based upon sensor data obtained by one or more sensors associated with the second set of actuators. The one or more sensors may be configured to detect changes in position of the plurality of labware components along the first directional axis caused by the plurality of processing heads.

Although the present description has focused, in at least some respects, on manipulating “processing heads” via actuators that are distinct from other actuators for manipulating labware components, it will be appreciated that the principles discussed herein can be applied in other contexts. For instance, various types of sensors may be actuated by a first set of actuators that is distinct from another set of actuators that moves labware (or other components). The sensors may be used to facilitated parallelized analysis operations (for instance, image capture or microscopy operations, temperature sensing operations, and/or others). Sensors may comprise any type of device configured to detect or measure physical phenomena, such as, by way of non-limiting example, temperature sensors, image or light sensors (for instance, CCD, CMOS, SPAD, and/or others), electric and/or magnetic field sensors, heat sensors, proximity or range or distance sensors, pressure sensors, microphones, particulate sensors, and/or others. It will thus be appreciated, in view of the present disclosure, that the discussion included herein related to “processing heads” and operations associated therewith (for instance, actuation, parallelized operation, selective attachment/detachment, etc.) is equally applicable to “sensor heads” and/or other tools configured to facilitate analysis of labware components. “Lab Operations” may include processing and/or analysis of labware components. “Processing heads” and “sensor heads” may both be regarded as “interactors” that are configured to interact with labware components (whether to perform liquid handling or other physical manipulation of labware components or analysis of labware components).

### Additional Computer System Details

Disclosed embodiments may comprise or utilize a special purpose or general-purpose computer including computer hardware, as discussed in greater detail below. In some instances, the techniques discussed herein are represented in computer-executable instructions that may be stored on one or more hardware storage devices. The computer-executable instructions may be executable by one or more processors to carry out (or to configure a system to carry out) the disclosed techniques. The processor(s) may comprise one or more sets of electronic circuitries that include any number of logic units, registers, and/or control units (for instance, microcontrollers) to facilitate the execution of computer-readable instructions (for instance, to control the actuators, processing heads, etc.). In some embodiments, a system may be configured to send the computer-executable instructions to a remote device to configure the remote device for carrying out the disclosed techniques.

Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (for instance, a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code.

Disclosed embodiments may comprise or utilize cloud computing. A cloud model can be composed of various characteristics (for instance, on-demand self-service, broad network access, resource pooling, rapid elasticity, measured service, etc.), service models (for instance, Software as a Service (“SaaS”), Platform as a Service (“PaaS”), Infrastructure as a Service (“IaaS”), and deployment models (for instance, private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (for instance, local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (for instance, as separate threads).

In some implementations, systems of the present disclosure may comprise or be configurable to execute any combination of software and/or hardware components that are operable to facilitate processing using machine learning models or other artificial intelligence-based structures/architectures. For example, one or more processors may comprise and/or utilize hardware components and/or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that systems, devices, products, kits, methods, and/or processes, according to certain embodiments of the present disclosure may include, incorporate, or otherwise comprise properties, features (for instance, components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

What is claimed is:

1. A system for facilitating parallelized lab operations, comprising:
a plurality of labware components;
a plurality of processing heads configured to interact with the plurality of labware components to facilitate a plurality of parallel lab operations;
a first set of actuators coupled to the plurality of processing heads, the first set of actuators being configured to actuate the plurality of processing heads along a first directional axis, singly or in parallel, to facilitate the plurality of parallel lab operations; and
a second set of actuators configured to translate the plurality of labware components along at least a second directional axis and a third directional axis, the second directional axis and the third directional axis being angularly offset from the first directional axis and from one another, the second set of actuators being configurable to selectively translate at least some of the plurality of labware components into alignment with the plurality of processing heads preparatory to actuation of the plurality of processing heads along the first directional axis via the first set of actuators to facilitate the plurality of parallel lab operations,
wherein the second set of actuators comprises one or more magnetic levitation systems configured to cause movement of the plurality of labware components along the second directional axis and the third directional axis.

2. The system of claim 1, wherein the first set of actuators and the second set of actuators are configured as independent actuators to independently actuate (i) one or more interactors and (ii) one or more labware components.

3. The system of claim 1, wherein the one or more labware components are positioned on one or more actuatable carriers that are actuatable independent of the one or more interactors, wherein the independent actuators that independently actuate the one or more interactors is/are positionally fixed in an x-direction and a y-direction, and wherein the independent actuators that independently actuate the one or more labware components is/are movable in the x-direction and the y-direction.

4. The system of claim 1, wherein the plurality of labware components comprises one or more fluid vessels, such as one or more tubes, beakers, flasks, reservoirs, troughs, well plates, cell-culture dishes, slides, slide holders, waste containers, and/or washing reservoirs, one or more of pipettors, grippers, dispensers, aspirators, well washing devices, plate sealers, seal peelers, colony pickers, tube cappers/decappers, tube pickers, magnetic bead collection/transfer components, pin tools, voltage supplies, illumination components, heating or cooling components, pneumatic/hydraulic components, and/or sensors.

5. The system of claim 1, wherein the plurality of parallel lab operations comprises one or more of single aspiration, serial aspiration, single dispensation, serial dispensation, tip changing, tip mixing, cherry picking, labware transfer, well washing, plate sealing, seal penetration or removal, colony picking, tube capping or de-capping, tube transfer, and/or magnetic bead manipulation.

6. The system of claim 1, wherein the plurality of processing heads comprises one or more pipettors, one or more grippers, and one or more additional processing heads, wherein, the one or more additional heads comprise a device, wherein the device is selected from a group consisting of a dispenser, a well washing device, a plate sealer, a seal peeler, a tube capper/decapper, a tube picker, or a combination thereof.

7. The system of claim 1, wherein processing heads of the plurality of processing heads are selectively interchangeable.

8. The system of claim 1, wherein the first set of actuators comprises one or more linear actuators, such as one or more ball screw actuators and/or linear actuators.

9. The system of claim 1, wherein actuators of the first set of actuators are not configured to cause translation of the plurality of processing heads along the second directional axis and the third directional axis, such that the plurality of processing heads are arranged at fixed coordinates on the second directional axis and the third directional axis.

10. The system of claim 1, wherein the second set of actuators is configured to rotate the plurality of labware components about the first directional axis, the second directional axis, and/or the third directional axis.

11. The system of claim 1, wherein the second set of actuators is configured to move the plurality of labware components along the first directional axis.

12. The system of claim 1, further comprising one or more sensors associated with the second set of actuators, the one or more sensors being configured to detect changes in position of the plurality of labware components along the first directional axis caused by the plurality of processing heads, wherein the second set of actuators is configured to selectively modify positioning of the plurality of labware components along the first directional axis based upon sensor data obtained by the one or more sensors.

13. The system of claim 1, wherein the second set of actuators is configured to translate the plurality of labware components along the second directional axis and the third directional axis without utilizing actuation or gripping members that extend above the plurality of labware components on the first directional axis, wherein the second set of actuators comprises a plurality of rollers or wheels configured to cause movement of the plurality of labware components along the second directional axis and the third directional axis.

14. The system of claim 1, wherein the one or more magnetic levitation systems comprise a magnetic coil matrix and a plurality of magnetic trays, the plurality of magnetic trays supporting the plurality of labware components, the magnetic coil matrix being controllable to facilitate levitation of the plurality of magnetic trays along the first directional axis and movement of the plurality of magnetic trays along the second directional axis and the third directional axis.

15. The system of claim 1, wherein the system further comprises a surface over which the second set of actuators are configured to translate the plurality of labware components along at least the second directional axis and the third directional axis, wherein the surface comprises a plurality of interaction zones, the plurality of interaction zones comprising a respective interaction zone for each of the plurality of processing heads, wherein selectively translating the at least some of the plurality of labware components into alignment with the plurality of processing heads comprises selectively translating the at least some of the plurality of labware components into the plurality of interaction zones.

16. The system of claim 15, wherein the surface further comprises one or more user interaction zones that are separate from the plurality of interaction zones, the second set of actuators being configured to translate labware components of the plurality of labware components to the one or more user interaction zones to enable one or more users to interact with the labware components.

17. The system of claim 1, wherein the second set of actuators is configured to translate at least one receptacle along the second directional axis and the third directional axis to an integration zone, the at least one receptacle being configured for receiving or delivering the one or more consumable components.

18. The system of claim 1, further comprising one or more image sensors configured to capture image data depicting one or more aspects of the plurality of labware components, the plurality of processing heads, the first set of actuators, or the second set of actuators, wherein the system is configured to utilize the image data to facilitate the plurality of parallel lab operations.

19. The system of claim 1, further comprising: one or more
processors; and
one or more hardware storage devices storing instructions that are executable by the one or more processors to configure the system to facilitate the parallelized lab operations by configuring the system to:
translate, via the second set of actuators, a first labware component of the plurality of labware components into alignment with a first processing head of the plurality of processing heads;
translate, via the second set of actuators, a second labware component of the plurality of labware components into alignment with a second processing head of the plurality of processing heads; and
actuate, via the first set of actuators, the first processing head and the second processing head in parallel to cause the first processing head to interact with the first labware component and to cause the second processing head to interact with the second labware component,
wherein the second set of actuators comprises one or more magnetic levitation systems configured to cause movement of the first labware component and the second labware component.

20. A method for facilitating parallelized lab operations, comprising:
translating, via a second set of actuators, a first labware component of a plurality of labware components into alignment with a first processing head of a plurality of processing heads, the second set of actuators being configured to translate labware components of the plurality of labware components along at least a second directional axis and a third directional axis;
translating, via the second set of actuators, a second labware component of the plurality of labware components into alignment with a second processing head of the plurality of processing heads; and
actuating, via a first set of actuators, the first processing head and the second processing head in parallel to cause the first processing head to interact with the first labware component and to cause the second processing head to interact with the second labware component, the first set of actuators being coupled to the plurality of processing heads and being configured to actuate the plurality of processing heads along a first directional axis that is angularly offset from the second directional axis and the third directional axis,
wherein the second set of actuators comprises one or more magnetic levitation systems configured to cause movement of the plurality of labware components along the second directional axis and the third directional axis.
